(19) United States
(12) Patent Application Publication
(10) Pub. No.: US 2009/0301355 A1
(43) Pub. Date: Dec. 10, 2009

(54) Cementitious Composition and Concrete of Such Composition

(76) Inventor: Hallvar Eide, Orskog (NO)

Correspondence Address: DENNISON, SCHULTZ & MACDONALD, 1727 KING STREET, SUITE 105, ALEXANDRIA, VA, 22314, US

(21) Appl. No.: 11/919,428

(22) PCT Filed: Apr. 26, 2006
(86) PCT No.: PCT/NO2006/000153

§ 371 Date: Dec. 19, 2007

(30) Foreign Application Priority Data
Apr. 26, 2005 (NO) 20052035

(51) Int. Cl. C04B 7/02; C04B 7/00

(52) U.S. Cl. 106/737; 106/817; 106/816

(57) ABSTRACT

A cementitious composition comprising an hydraulic cement and one or more aggregates being added to or mixed with the cement and water. The cement contains more than 20 percent of weight micronized aplite.

The invention is directed towards a cementitious composition as indicated in the preamble of claim 1, and a concrete of such cementitious composition.

### BACKGROUND

Cementitious compositions containing hydraulic cement have been developed for a long time. Ordinarily, concrete is poured consisting in Portland cement or “standard cement”, i.e. according to ISO standards. It may be based on a composition of limestone and different correction materials, gypsum and quartz, among others, being burned at about 1500° C. The burned clinker is pulverized and small amounts of limestone, gypsum and ferrous sulphate, possibly also fly ash and silica, are added. When water is added to this composition, complex reactions will occur causing the cement to harden. Different aggregates are normally added to the viscous mass to give the final product characteristics that will be suitable for different purposes. In this way several different types of concrete are made. In concrete for construction purposes aggregates consisting of sand and grit and other different minerals are most common.

It is known in the art to add an aggregate consisting in granulate of the granite type aplite to obtain a particularly abrasion proof concrete. However, this has not created a concrete which is both completely dense and highly durable. Aplite is found, among other places, in Montpellier, Vir., USA, Owens Vally, Calif., USA, Finnvolldalen in Norway, in Tuscany Italy and in certain areas in Russia and Japan. Aplite is commercially available from Maffei Natural Resources Italia and from US Silica Company, West Virginia, USA. Aplite typically consists of silicon, magnesium, iron, sodium, aluminium, potassium, titanium and calcium, the most important components being silicon and aluminium (in the form of oxides), typically present in the relative amount of 60-85 and 10-25 percent in weight, respectively.

Japanese patent 72033048 (Shiga-Ken 1972) discloses the use of aplite as the main aggregate in a cementitious composition of aluminous cement. Together with other aggregates and a foaming agent this results in a porous concrete product.

Several other materials have been tried as components in cements. The adding of a number of different plasticizers, to be able to reduce the water content of the fresh cement, has for instance been proposed. In spite of this, there is still a need for better and stronger cements for demanding applications.

U.S. Pat. No. 6,024,791 discloses a cement composition comprising up to 20 percent by weight of a powdery material selected from materials like glass, silica fume, aplite and blast furnace cinders. There is no suggestion in this patent that a particular one of these materials would be more suitable than others.

U.S. Pat. No. 3,945,840 discloses a non-combustable material produced from a) an inorganic compound containing silica and an inorganic compound being a source of calcium oxide, b) mineral fibres and c) a compound selected from bitumen, crystalline aluminium oxide, sulphur, metallic sulphide and vanadium oxide. It is suggested that aplite could be a source of the compound under a). One notes in this patent that cement or gypsium should not be part of the composition (col. 1, lines 54-58), as this would create undesirable product characteristics.

### OBJECTS

The main object of the invention is to provide an improved cementitious composition that can be utilized for different purposes where high strength, low shrinkage, dense structure and high durability are important.

It is also an object to provide a cementitious composition which can be adapted for use in combination with known cements and different known aggregates, so that it may be utilized for different special purposes where unusual demands are made, e.g. demands for a high heat resistance, resistance against aggressive chemicals and/or high pressure.

There exists a need for a versatile cementitious composition that can be used for the production of concrete on site, in buildings and on construction sites, for bridges and other constructions, for the production of plate elements, containers, etc.

### THE INVENTION

According to a first aspect the invention is related to a cementitious composition as disclosed in claim 1. According to another aspect the present invention is related to a concrete made of such a composition and as disclosed in claim 17. The invention is further related to the use of aplite as disclosed in claim 18.

Preferred embodiments of the invention will be apparent from the dependent claims. The term “micronized” used herein means a powder material where the particle size lies in the range of up to about 200 microns, preferably under 75 microns. The particle size so defined will comply with standard strainer sizes. When a particle size is indicated as being smaller than a given value, at least 50 percent of volume, preferably at least 80 percent of volume of the particle will be able to pass through a strainer having the mesh size given. If in some cases too small a portion of the particles is able to pass through such a strainer, the particles held back may be conveyed for grinding in conventional grinding equipment.

Aplite is a granitic rock mainly composed of quartz and feldspar. It exists, as noted above, in different continents and is available in different qualities. In connection with the invention a quartz content, measured as the portion of SiO₂, in the range of 68-90 percent of volume will be desirable, more preferably in the area of 68-90 percent of volume.

Preferably, the aplite used will be naturally existing aplite, but reference, in this publication, to the term “aplite” will in general include combinations of the most important rocks contained in naturally existing aplite.

The cement may consist of as much as 100% micronized aplite, but preferably consists of from 20 to 80 percent by weight micronized aplite, and from 20 to 80 percent by weight hydraulic cement such as, but not limited to, Portland cement. Other hydraulic cements can be used including pozzolanic cements, gypsum cements, alumina cements, silica cements and slag cements. The benefits from the cementitious composition of the invention will already be evident with a content of aplite lower than 35 percent in weight, regarding shrinkage, but will improve as the content of aplite is increased. The benefits in the form of increased strength will, in order to be evident, demand some higher portion of aplite. Preferably, the cement therefore contains at least 50 percent by weight micronized aplite, and if the cement consists of 75 percent by weight micronized aplite and 25 percent by weight Portland cement, this will be particularly advantageous. The presence of a considerable amount of aplite in the cement will present several advantages of which a distinctive advantage is that the cement upon hardening is subject to a very low reduction in volume (shrinkage). With no aplite the shrinkage can be up to 4 percent of volume, but with a content of aplite of 28% it is measured to be 1.2 percent of volume, with 33-50% content of aplite measured as low as 0.7 percent of volume and with a 60% content of aplite measured to 0.2 percent of volume. Preferably the shrinkage upon hardening will be less than 3 percent of volume, more preferably less than 1.5 percent of volume and, most preferably, less than 0.7 percent of volume.

In addition to quartz from aplite, quartz from other sources may, if desirable, be added to the cement.

Up to 20 percent by weight of calcite may advantageously be added to the cementitious composition. Calcite is a form of limestone and is used in a finely ground form that does not need to be as strongly micronized as the main constituents of the cement. The addition of calcite primarily contributes to the durability of the concrete.

Adding carbon fibres to the cementitious composition may advantageously affect it in different ways. The most obvious of these advantages will be apparent in respect to the characteristics of the cement upon hardening. However, carbon fibres in the cement will also contribute to its ability to keep moist, maintaining the water content of the cementitious composition in situations where this is particularly favourable. Loss of moisture will, for example, often be a problem when pouring in subterranean formations. For the hardened cement the presence of carbon fibres results in higher compressive and tensile strength. The carbon fibres may be provided in the form of individual fibres (single fibres) or in the form of fibre mats, woven or knitted or in some other manner structured into a contiguous unit. As single fibres these will typically have a length of 1 to 100 mm, preferably in the area of 3-70 mm, and more preferably in the area of 5-10 mm. Preferred fibres have a diameter of 1 to 15 μm, more preferably between 3 and 10 μm and most preferably between 6 and 8 μm. Suitable fibres are commercially available from Devold AMT AS, N-6030 Langevåg, Norway.

An aggregate consisting of aplite granulate may advantageously be added to the cementitious composition. Other possible aggregates will be one or more of the following materials: sand, grit, anhydrite, glass, foamed glass.

The application of micronized aplite as a constituent in a cementitious composition will be within the scope of the invention.

### EXAMPLE

Tests have been done using standard commercially available Portland cement of the type Norcem “G” containing a varying portion of micronized aplite from Finnvolldalen in Nord-Trøndelag having between 70 and 90 percent of weight SiO₂, the average being 82 percent of weight. This was compared with a cement without such a portion. Two different hardening temperatures and hardening times were used. The measurements were done using an Ultrasonic Cement Analyzer (UCA) and according to “API Recommended Practice for Testing Well Cements”, 22. edition, 1997. The results are given in Table 1 below.

TABLE 1

| | Composition | | | | |
|---|---|---|---|---|---|
| | Norcem “G”:aplite | | | Final | |
| Test | (percent of | Time | | strenght | Shrinkage |
| no. | weight) | (t) | Temp (C.) | (bar) | (%) |
| 1 | 100:0 (0) | 24 | 150 | 227.1 | 3.4 |
| 2 | 100:40 (28) | 24/68 | 150 | 220.6/179.3 | 1.2 |
| 3 | 100:50 (33) | 24/68 | 150 | 237.9/220.6 | 0.7 |
| 4 | 100:75 (42.8) | 24/68 | 150 | 344.8/297.6 | 1.2 |
| 5 | 100:100 (50) | 24/68 | 150 | 399.9/375.0 | 0.7 |
| 6 | 100:150 (60) | 24/68 | 150 | 551.6/487.4 | 0.2 |
| 7 | 100:75 (42.8) | 24/48 | 20 | 110.3/273.2 | NA |
| 8 | 100:150 (60) | 24/48 | 20 | 275.8/390.4 | NA |

Table 1 indicates increasing strength and reduced shrinkage with increasing content of aplite in the cement. The cementitious composition is thus well suited for fulfilling the above mentioned purposes of the invention. It will be possible to increase the strength of the concrete compared to the examples given above, e.g. by the choice of aggregate.

1-19. (canceled)

20. A cementitious composition comprising an hydraulic cement and one or more aggregates being added to or mixed with the cement and water, wherein the cement contains more than 20 percent by weight of micronized aplite.

21. A cementitious composition according to claim 20 wherein the cement comprises micronized aplite.

22. A cementitious composition according to claim 20 wherein the cement comprises from 80 to 20 percent by weight of micronized aplite and from 20 to 80 percent by weight of hydraulic cement.

23. A cementitious composition according to claim 20 wherein the cement comprises at least 50 percent by weight of micronized aplite.

24. A cementitious composition according to claim 20 wherein the cement comprises 75 percent by weight of micronized aplite and 25 percent by weight of hydraulic cement.

25. A cementitious composition according to claim 20 wherein the hydraulic cement is selected from the group consisting of Portland cement, pozzolanic cements, gypsum cements, alumina cements, silica cements and slag cements.

26. A cementitious composition according to claim 20 wherein at least 80% of the aplite is of a particle size less than 200 microns.

27. A cementitious composition according to claim 2- wherein the aplite is of a particle size less than about 75 microns.

28. A cementitious composition according to claim 20 wherein aplite comprises silica (quartz) in an amount of from 60-95 percent by weight, or more preferably, in an amount of from 68-90 percent by weight.

29. A cementitious composition according to claim 28 wherein the silica (quartz) is from a source other than from aplite.

30. A cementitious composition according to claim 20 wherein finely ground calcite in an amount up to about 20 percent by weight is added to the cementitious composition.

31. A cementitious composition according to claim 20 wherein carbon fibers having a length of form 1-100 mm, preferably 3-70 mm, are added to the cementitious composition.

32. A cementitious composition according to claim 31 wherein the carbon fibers have a diameter in the range of from 1 to 15 microns, preferably form 3 to 10 microns, and more preferably from 6 to 8 microns.

33. A cementitious composition according to claim 20 wherein an aggregate consisting of aplite granulate is added to the composition.

34. A cementitious composition according to claim 20 wherein at least one or more of sand, grit, anhydrite, glass and foamed glass are used as aggregate.

35. A cementitious composition according to claim wherein upon hardening the composition shrinks less than 3%, preferably less than 1.5% and, most preferably, less than 0.7%.

36. A concrete produced from a cementitious composition according to claim 20.
